(19) United States
(12) Patent Application Publication
(10) Pub. No.: US 2026/0105107 A1
(43) Pub. Date: Apr. 16, 2026

(54) INFORMATION PROCESSING APPARATUS, RELATED WORD DETECTION METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 19/104,404

(22) PCT Filed: Aug. 24, 2022
(86) PCT No.: PCT/JP2022/031858

§ 371 Date: Feb. 18, 2025

(51) Int. Cl. G06F 16/93; G06F 16/9032; G06F 16/906; G06F 40/279

(52) U.S. Cl. CPC G06F 16/93; G06F 16/9032; G06F 16/906; G06F 40/279

(57) ABSTRACT

In order to detect, without using a learned model, a related word which is not included in a target document but is related to the target document, an information processing apparatus (1) includes: a related document retrieval section (11) that retrieves, with use of an extracted word extracted from the target document, a related document related to the extracted word; and a related word detection section (12) that detects, from among candidate words extracted from the related document detected by the related document retrieval means, a related word related to the target document.

### TECHNICAL FIELD The present invention relates to a technology for detecting a keyword related to a document.

### BACKGROUND ART

A technology for detecting a keyword from a document has been proposed. For example, Non-Patent Literature 1 discloses a technology for extracting an important keyword with use of a document summarization model. In the technology disclosed in Non-Patent Literature 1, a group of word vectors similar to embedded vectors in a whole document is extracted. This allows extracting words which capture context.

Further, Non-Patent Literature 2 discloses a text-to-text model trained with use of documents and desirable keywords as training data. The text-to-text model disclosed in Non-Patent Literature 2 makes it possible to output, as a keyword, a word not appearing in the document.

### CITATION LIST

### Non-Patent Literature

### Non-patent Literature 1

Xinnian Liang et. al., “Unsupervised Keyphrase Extraction by Jointly Modeling Local and Global Context”, 15 Sep. 2021

### Non-patent Literature 2

Colin Raffel et. al., “Exploring the Limits of Transfer Learning with a Unified Text-to-Text Transformer”, 28 Jul. 2020

### SUMMARY OF INVENTION

### Technical Problem

However, with the technology disclosed in Non-Patent Literature 1, it is not possible to output a word that does not appear in the text. With the text-to-text model disclosed in Non-Patent Literature 2, a word not appearing in the document can also be outputted, but re-training of the model is necessary in order to handle a word in a field not included in the training data or a word to be newly added.

An example aspect of the present invention has been made in view of the above problems, and an example object thereof is to provide a technology that makes it possible to detect, without using a learned model, a related word which is not included in a target document but is related to the target document.

### Solution to Problem

An information processing apparatus in accordance with an example aspect of the present invention includes: a related document retrieval means that retrieves, with use of an extracted word extracted from a target document, a related document related to the extracted word; and a related word detection means that detects, from among candidate words extracted from the related document detected by the related document retrieval means, a related word related to the target document.

A related word detection method in accordance with an example aspect of the present invention includes: retrieving, by at least one processor and with use of an extracted word extracted from a target document, a related document related to the extracted word; and detecting, by the at least one processor and from among candidate words extracted from the related document, a related word related to the target document.

A related word detection program in accordance with an example aspect of the present invention is a related word detection program for causing a computer to function as: a related document retrieval means that retrieves, with use of an extracted word extracted from a target document, a related document related to the extracted word; and a related word detection means that detects, from among candidate words extracted from the related document detected by the related document retrieval means, a related word related to the target document.

### Advantageous Effects of Invention

An example aspect of the present invention makes it possible to detect, without using a learned model, a related word which is not included in a target document but is related to the target document.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of a related word detection method in accordance with the first example embodiment.

FIG. 3 is a view illustrating an outline of a related word detection method in accordance with a second example embodiment.

FIG. 4 is a block diagram illustrating a configuration of an information processing apparatus in accordance with the second example embodiment.

FIG. 5 is a view illustrating an example screen in accordance with the second example embodiment to be used by a user in order to designate a granularity.

FIG. 6 is a flowchart illustrating a flow of a process carried out by the information processing apparatus in accordance with the second example embodiment.

FIG. 7 is a view illustrating an example screen displaying a related word, the example screen being outputted by the information processing apparatus in accordance with the second example embodiment.

FIG. 8 is a view illustrating an example of a computer which executes instructions of a program that is software realizing functions of the apparatus according to each of the example embodiments of the present invention.

### EXAMPLE EMBODIMENTS

### First Example Embodiment

The following description will discuss a first example embodiment of the present invention in detail with reference to drawings. The present example embodiment is an embodiment serving as a basis for example embodiments described later.

### Configuration of Information Processing Apparatus

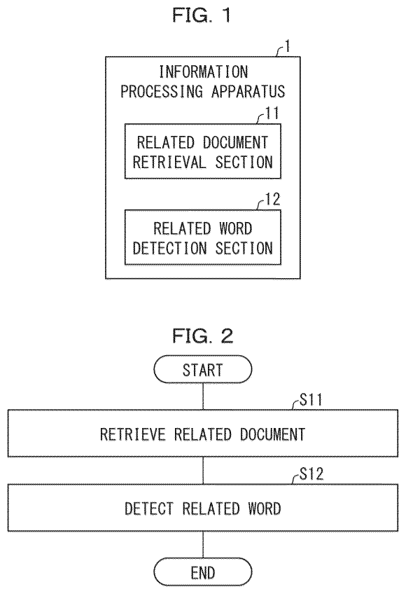

The following will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes a related document retrieval section 11 (related document retrieval means) and a related word detection section 12 (related word detection means).

The related document retrieval section 11 retrieves, with use of an extracted word extracted from a target document, a related document which is related to the extracted word. The related word detection section 12 detects, from among candidate words extracted from the related document detected by the related document retrieval section 11, a related word related to the target document.

As described above, the information processing apparatus 1 in accordance with the present example embodiment employs a configuration in which the information processing apparatus 1 includes: the related document retrieval section 11 that retrieves, with use of an extracted word extracted from a target document, a related document related to the extracted word; and the related word detection section 12 that detects, from among candidate words extracted from the related document detected by the related document retrieval section 11, a related word related to the target document. As such, the information processing apparatus 1 in accordance with the present example embodiment makes it possible to detect, without using a learned model, a related word which is not included in a target document but is related to the target document.

### Related Word Detection Program

The above functions of the information processing apparatus 1 can also be realized by a program. A related word detection program in accordance with the present example embodiment causes a computer to function as: a related document retrieval means that retrieves, with use of an extracted word extracted from a target document, a related document related to the extracted word; and a related word detection means that detects, from among candidate words extracted from the related document detected by the related document retrieval means, a related word related to the target document. The related word detection program makes it possible to detect, without using a learned model, a related word which is not included in a target document but is related to the target document.

### Flow of Related Word Detection Method

The following description will discuss a flow of a related word detection method in accordance with the present example embodiment, with reference to FIG. 2. FIG. 2 is a flowchart illustrating the flow of the related word detection method. Note that steps of the related word detection method may be carried out by a processor of the information processing apparatus 1 or by a processor of another apparatus. Alternatively, the steps may be carried out by processors provided in respective different apparatuses.

In S11, at least one processor retrieves, with use of an extracted word extracted from a target document, a related document related to the extracted word.

In S12, the at least one processor detects, from among candidate words extracted from the related document, a related word related to the target document.

As described above, the related word detection method in accordance with the present example embodiment includes retrieving, by at least one processor and with use of an extracted word extracted from a target document, a related document related to the extracted word; and detecting, by the at least one processor and from among candidate words extracted from the related document, a related word related to the target document. The related word detection method makes it possible to detect, without using a learned model, a related word which is not included in a target document but is related to the target document.

### Second Example Embodiment

### Outline of Related Word Detection Method

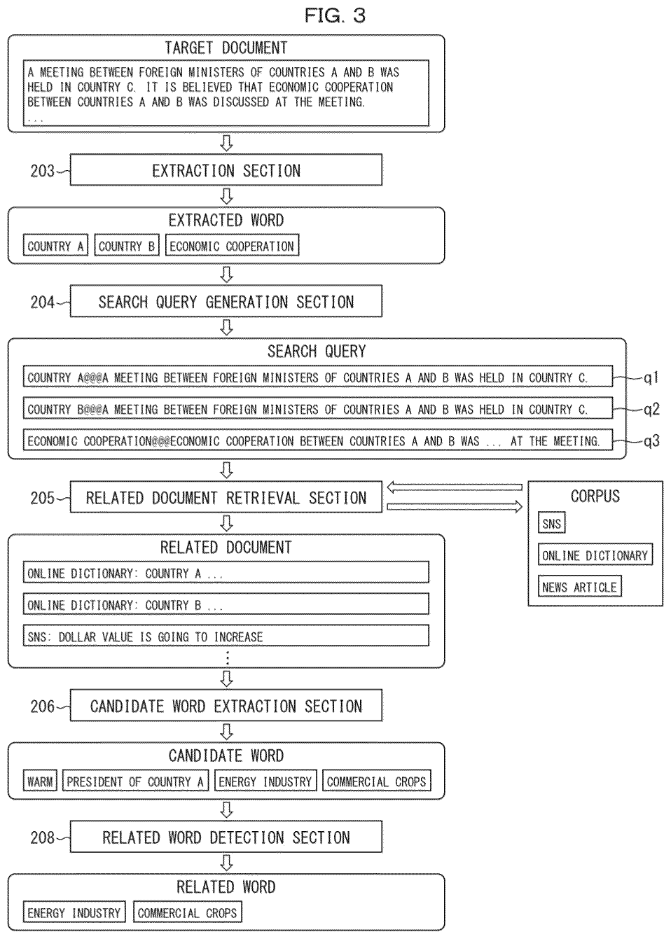

The following will discuss in detail a second example embodiment of the present invention, with reference to drawings. FIG. 3 is a view illustrating an outline of a related word detection method in accordance with the present example embodiment (hereinafter referred to as the present method). The present method is a method of detecting a related word related to a target document. Note here that the target document is a document which includes one or more sentences. The target document may be represented, for example, in the form of unstructured data such as text data, image data, and audio data or in the form of semistructured data in eXtensible Markup Language (XML) format or the like. The related word is a word which is not included in the target document but is related to the target document. In the example illustrated in FIG. 3, “energy industry” and “commercial crop”are related words.

In the present method, firstly, an extraction section 203 extracts an extracted word from the target document. Note here that the extracted word is a word that is included in the target document. It can be said that the extracted word is an important keyword included in the target document. In the example illustrated in FIG. 3, “country A”, “country B”, and “economic cooperation” are extracted words. The extracted word, for example, is extracted from the target document with use of the document summarization model disclosed in Non-Patent Literature 1 above.

Subsequently, in the present method, a search query generation section 204 generates a search query with use of the extracted word. The search query, for example, is a combination of the extracted word and a sentence containing the extracted word (a sentence extracted from the target document). Note that the search query is not limited to the above example, and may be another query. The search query may be, for example, the extracted word itself.

Subsequently, in the present method, a related document retrieval section 205 retrieves, with use of the search query, a related document from a corpus including a plurality of documents. Note that examples of the corpus encompass an external corpus such as an online dictionary, news articles, a social networking service (SNS), and the like. The corpus may include a reconstructed document generated by reconstruction of a document included in the corpus. The related document is a document related to the extracted word, and is, for example, a document included in the corpus or a part of a document included in the corpus. The related document may be the above-described reconstructed document.

Subsequently, in the present method, a candidate word extraction section 206 extracts candidate words from the related document. The candidate words are words which are included in the related document and which are candidates for the related word. The candidate words, for example, are extracted from the related document with use of the document summarization model disclosed in Non-Patent Literature 1 above. In the example illustrated in FIG. 3, “warm”, “president of country A”, “energy industry”, and “commercial crop” are candidate words.

Subsequently, in the present method, a related word detection section 208 detects a related word from the extracted candidate words. Some of the candidate words have little relevance to the target document. For example, in the example illustrated in FIG. 3, the candidate words “warm” and “president of country A” have little relevance to content of the target document. As such, in the present method, a word related to the target document among the candidate words are detected as the related word. The related word is a word which is not included in the target document but is related to the target document, as described above. The related word can also be said to be a keyword that is thought of in association with the target document. The related word, for example, is outputted by, for example, being displayed on a display and is presented to a user.

### Configuration of Information Processing Apparatus

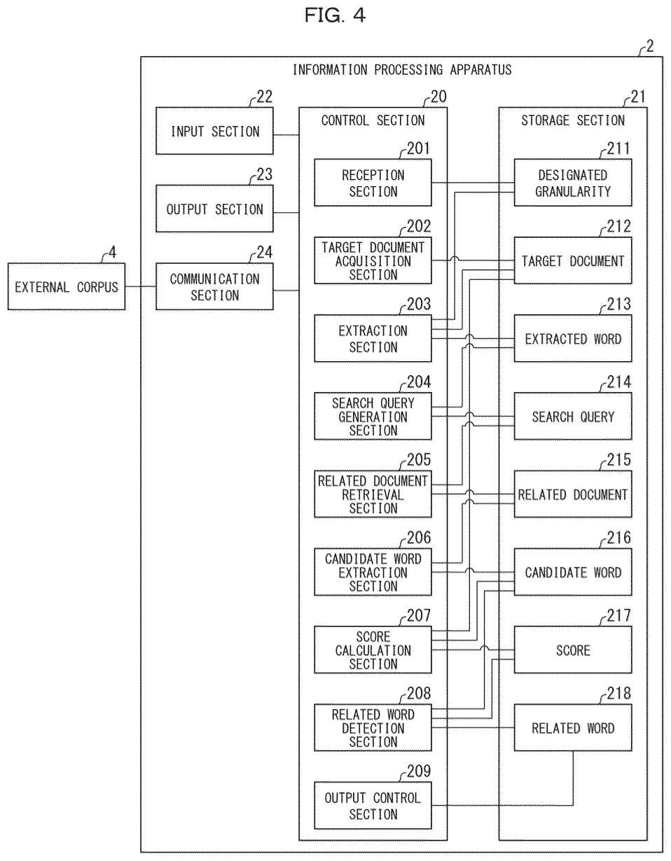

FIG. 4 is a block diagram illustrating a configuration of an information processing apparatus 2 in accordance with the second example embodiment. The information processing apparatus 2 is an apparatus which detects a related word related to a target document. As illustrated in FIG. 4, the information processing apparatus 2 includes a control section 20 which collectively controls sections of the information processing apparatus 2, and a storage section 21 which is a storage apparatus storing therein various data used by the information processing apparatus 2. Further, the information processing apparatus 2 includes an input section 22 which receives a user's input operation with respect to the information processing apparatus 2 and an output section 23 which allows the information processing apparatus 2 to output data. The information processing apparatus 2 includes a communication section 24 which allows the information processing apparatus 2 to communicate with another apparatus via a communication line. The information processing apparatus 2 may be an apparatus dedicated for extraction of a related word, or may be a versatile apparatus that can be used for other purposes as well.

The control section 20 includes a reception section 201 (reception means), a target document acquisition section 202, the extraction section 203 (extraction means), the search query generation section 204 (search query generation means), the related document retrieval section 205 (related document retrieval means), the candidate word extraction section 206 (candidate word extraction means), a score calculation section 207 (score calculation means), the related word detection section 208 (related word detection means), and an output control section 209. The storage section 21 stores therein a designated granularity 211, a target document 212, an extracted word 213, a search query 214, a related document 215, a candidate word 216, a score 217, and a related word 218.

The reception section 201 receives designation of a granularity in a hierarchy. In the present example embodiment, words constituting the target document are each classified in a hierarchical structure. In an example of a classification method, for example, each word is classified by a broad classification, a middle classification, and a detailed classification, and for example, a word “orange” is classified as “food” by the broad classification, “fruit” by the middle classification, and “citrus” by the detailed classification. The granularity in a hierarchy means a hierarchical depth of a word classified in a hierarchical structure. In the above example, the detailed classification is the deepest level in hierarchy (fine classification). Note that the granularity may be replaced with terms such as “depth”, “degree”, “level”, “position”, and “layer”.

The reception section 201 may acquire data which is indicative of the designation and is inputted via the input section 22. Alternatively, the reception section 201 may acquire the data indicative of the designation from a storage location designated by a user of the information processing apparatus 2 (the storage location may be in the storage section 21 of the information processing apparatus 2 or may be a storage apparatus outside the information processing apparatus 2). The reception section 201 causes the received designation of the granularity in a hierarchy to be stored in the storage section 21 as a designated granularity 211. The designated granularity 211 is used during an extraction of an extracted word by the extraction section 203.

The target document acquisition section 202 acquires a target document to be subjected to detection of a related word and causes the acquired target document to be stored in the storage section 21 as a target document 212. The target document acquisition section 202 may acquire a target document that is inputted via the input section 22. Alternatively, the target document acquisition section 202 may acquire a target document from a storage location designated by a user of the information processing apparatus 2 (the storage location may be in the storage section 21 of the information processing apparatus 2 or may be a storage apparatus outside the information processing apparatus 2). The target document is typically text data, but as described above, data in other formats may be used as the target document. That is, the “target document” only needs to include at least one sentence, and can be in any data format.

The extraction section 203 extracts an extracted word from the target document 212 and causes the extracted word to be stored in the storage section 21 as an extracted word 213. The extraction section 203, for example, extracts the extracted word 213 from among words constituting the target document 212, on the basis of the designated granularity 211. Note that the extraction section 203 may extract the extracted word 213 without referring to the designated granularity. A method of extracting the extracted word 213 by the extraction section 203 will be described later. Note that in a case where the target document acquisition section 202 acquires a target document in a data format other than text data, the extraction section 203 may convert the acquired target document into text data and extract an extracted word from the text data.

The search query generation section 204 generates, with use of the extracted word 213 extracted by the extraction section 203, a search query for use in retrieval of a related document and causes the search query to be stored in the storage section 21 as a search query 214. For example, the search query generation section 204 generates a search query 214 that includes (i) the extracted word 213 extracted from the target document 212 and (ii) a sentence included in the target document 212 and containing the extracted word 213. A method of generating the search query 214 by the search query generation section 204 will be described later.

The related document retrieval section 205 retrieves, with use of the search query 214, a related document from a corpus including a plurality of documents. Examples of the corpus to be searched for a related document encompass an external corpus 4 connected via the communication section 24. Note that an internal corpus may be provided in the storage section 21, and in this case, the internal corpus may be subjected to search in place of or in addition to the external corpus 4. The related document retrieval section 205 causes the retrieved related document to be stored in the storage section 21 as a related document 215. A method of retrieving a related document 215 by the related document retrieval section 205 will be described later.

The candidate word extraction section 206 extracts candidate words from the related document 215 and causes the candidate words to be stored in the storage section 21 as candidate words 216. The method of extracting the candidate words 216 by the candidate word extraction section 206 will be described later.

The score calculation section 207 calculates a score that is an index value indicative of a relevance between the target document 212 and each of the candidate words 216, and causes the score to be stored in the storage section 21 as a score 217. For example, the score calculation section 207 calculates, with use of a scorer used for calculation of a score indicative of a relevance between a search word and a website in a search engine, a score that is indicative of a relevance between the target document 212 and each of the candidate words 216.

The related word detection section 208 detects a related word from among the candidate words 216 and causes the related word to be stored in the storage section 21 as a related word 218. The related word detection section 208, for example, detects the related word 218 from among the candidate words 216 on the basis of the score 217 calculated by the score calculation section 207. Note that the technique in which the related word detection section 208 detects the related word 218 is not limited to the above example, and the related word detection section 208 may detect the related word 218 from the candidate words 216 by another technique.

The output control section 209 causes the related word 218 to be outputted to an output apparatus. The output apparatus to which the related word 218 is outputted is, for example, connected to the output section 23 or the communication section 24. Examples of the output apparatus encompass: a display apparatus such as a liquid crystal display or a touch panel; a speaker which outputs audio; and a projector. Note that the output apparatus is not limited to the above examples, and may be another output apparatus.

### Extraction of Extracted Word

The following will describe a method of extraction of the extracted word 213 by the extraction section 203. The extraction section 203, for example, may extract the extracted word 213 from the target document 212 with use of the document summarization model disclosed in Non-Patent Literature 1 above. Further, the extraction section 203 may also extract the extracted word 213 from the target document 212 by the technique of named entity recognition.

In a case of using the technique of named entity recognition, the extraction section 203, for example, uses the technique of named entity recognition to infer a type of each word constituting the target document 212 and extract a word of a specific type (e.g., person name, country name, etc.) as the extracted word 213. Note here that the type of each word indicates a result of classification by named entity classification. In other words, the extraction section 203 may extract, as the extracted word 213, a word of a type that matches a type included in a whitelist. Further, for example, the extraction section 203 may extract, as the extracted word 213, a word whose type is not a specific type among the words constituting the target document 212. In other words, the extraction section 203 may extract, as the extracted word 213, a word of a type other than types that are included in a blacklist.

Further, in a case where the plurality of types are classified in a hierarchical structure, the extraction section 203 may extract, as the extracted word 213, a word of a type corresponding to a specific hierarchical level. The specific hierarchical level may be a predetermined hierarchical level or a hierarchical level corresponding to a designated granularity 211 designated by a user's input operation. For example, in a case where the designated granularity 211 is “middle classification”, the extraction section 203 may extract, as the extracted word 213, a word for which a middle classification is set but no detailed classification is set. In this case, for example, the extraction section 203 may extract a word “apple”, which is classified as “food” by a broad classification and “fruit” by a middle classification, and not extract “Jonagold”, which is classified as “variety” by a detailed classification in addition to these classifications. Further, in this case, the extraction section 203 may convert “Jonagold” into “fruit”, which is a middle classification, and extract “apple” as the extracted word 213. Further, the granularity may be set in advance for each classification. In this case, the extraction section 203 may extract, as the extracted word 213, a word for which a designated granularity is set.

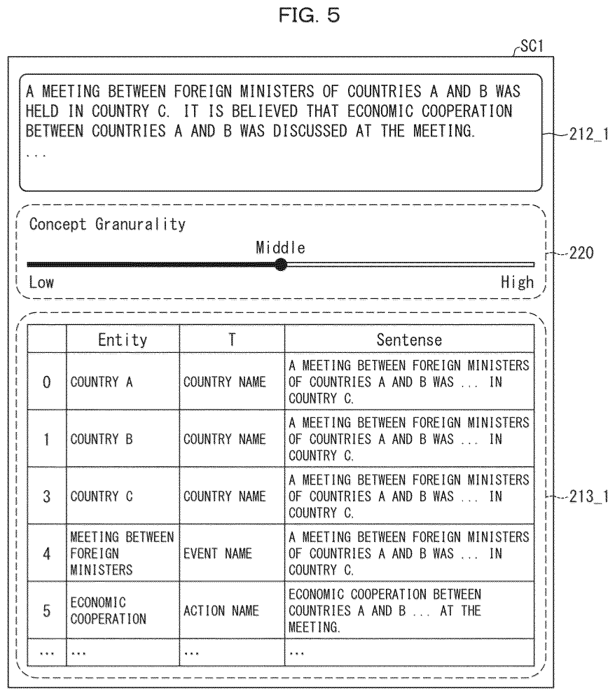

FIG. 5 is a view illustrating an example screen that allows a user to designate the designated granularity 211. A screen SC1 illustrated in FIG. 5 is displayed on, for example, an output apparatus (display) connected to the output section 23 or the communication section 24. The screen SC1 includes a target document 212_1, a slide bar 220, and an extracted word list 213_1.

The slide bar 220 is an object which allows a user to designate a designated granularity 211. The slide bar 220 on the screen SC1 allows a concept granularity to be selected by the following three levels of “low”, “middle”, and “high”. The user operates the slide bar 220 to designate a designated granularity 211. Of the words included in the target document 212_1, words that belong to a hierarchical level corresponding to the designated granularity 211 designated by the user are extracted and displayed on the screen SC1 as the extracted word list 213_1.

In a case where a plurality of types are classified in a hierarchical structure, the above-described whitelist may be prepared in advance for each hierarchical level, and the extraction section 203 may carry out extraction of the extracted word 213 with use of a whitelist corresponding to the designated granularity 211. Further, the blacklist may be prepared in advance for each hierarchical level, and the extraction section 203 may carry out extraction of the extracted word 213 with use of a blacklist corresponding to the designated granularity 211.

Further, the extraction section 203 may extract the extracted word 213 by combining a plurality of techniques. For example, the extraction section 203 may extract, as the extracted word 213, both an extracted word extracted with use of the document summarization model and an extracted word extracted by the technique of named entity recognition. Note that the technique in which the extraction section 203 extracts the extracted word 213 from the target document 212 is not limited to the above example, and the extraction section 203 may extract the extracted word 213 from the target document 212 by another technique.

On the extracted word list 213_1 on the screen SC1, a classification that is set for an extracted word and a sentence containing the extracted word in the target document 212_1 are displayed in addition to the extracted word. Since the classification and the sentence including the extracted word are displayed together with the extracted word, it is possible for a user to recognize what classification the extracted word belongs to and what context the extracted word is being used in, and to thereby easily select an extracted word that interests the user.

### Generation of Search Query

The following description will discuss a method by which the search query generation section 204 generates the search query 214. For example, the extracted word 213 extracted by the extraction section 203 may itself be used as the search query 214 by the search query generation section 204. Further, the search query generation section 204 may generate a search query 214 that includes the extracted word 213 and at least a part of N sentences (N is a natural number) around where the extracted word 213 occurs. In a case where N=1, the search query 214 includes the extracted word 213 and at least a part of the sentence containing the extracted word 213.

In the example illustrated in FIG. 3, a search query q1 includes “country A” as the extracted word 213 and a sentence containing “country A”. Further, the search query q2 includes “country B” as the extracted word 213 and a sentence containing “country B”. Further, the search query q3 includes “economic cooperation” as the extracted word 213 and a sentence containing “economic cooperation”.

### Retrieval of Related Document

The following description will discuss a method by which the related document retrieval section 205 retrieves the related document 215. The related document retrieval section 205 retrieves, with use of the search query 214, the related document 215 from a corpus including a plurality of documents. Note here that the corpus may include a reconstructed document which is generated by reconstruction of a document with use of an important word which is relatively high in importance among words included in the document. The important word, for example, may be a word to which a link is attached or a word to which a hashtag is attached among words included in the document. The important word may be, for example, a word extracted from information accompanying the document such as a document file property or an author name. The reconstructed document is, for example, a document in which important words are enumerated. The reconstructed document may be sentences constructed by supplementing important words with other words. The technique of generating sentences from words is not particularly limited, and for example, a known technique can be used.

Note that the corpus used by the related document retrieval section 205 may be one selected by a user. For example, in a case where the search query 214 is related to a news article, a user can select a corpus including news articles. Further, in a case where the search query 214 is related to a cooking recipe, a user can select a corpus including cooking recipes. In this way, since the user selects a corpus close to a characteristic of the search query, the related document retrieval section 205 can easily retrieve a document highly relevant to the search query.

The reconstructed document may be generated by the information processing apparatus 2 (for example, the related document retrieval section 205) or may be generated by another apparatus. That is, the reconstructed document is generated by any entity. Further, the reconstructed document may be generated by any method.

The related document retrieval section 205, for example, retrieves the related document 215 by a technique known as sparse retriever. That is, the related document retrieval section 205 considers a document having a high degree of overlapping of words between the search query 214 and the document to be the related document 215. Further, the related document retrieval section 205 may retrieve the related document 215 by a technique known as dense retriever. In this case, the related document retrieval section 205 vectorizes the search query 214 into an embedded vector and considers a document that is similar to the embedded vector in vector representation (a document close in inter-vector distance) to be the related document 215. Note that the technique in which the related document retrieval section 205 retrieves the related document 215 is not limited to the above example, and the related document retrieval section 205 may retrieve the related document 215 by another technique.

### Extraction of Candidate Words

The following description will discuss a method by which the candidate word extraction section 206 extracts the candidate words 216. The candidate word extraction section 206, for example, may extract the candidate words 216 from the related document 215 with use of the document summarization model disclosed in Non-Patent Literature 1 above. Further, the candidate word extraction section 206 may extract the candidate words 216 by the technique of named entity recognition. Extraction of the candidate words 216 by the technique of named entity recognition is similar to a technique in which the extraction section 203 extracts the extracted word 213 from the target document 212, and the description thereof will not be repeated here.

The candidate words 216 extracted from the related document 215 also include those extracted from accompanying information or structure information accompanying the related document 215. In other words, the candidate word extraction section 206 extracts, as the candidate words 216, important words which are relatively high in importance and identified on the basis of at least one of selected from the group consisting of: structure information indicative of a structure of the related document 215; and accompanying information which accompanies the related document 215. Note here that the structure information is, for example, information pertaining to a link attached to a word included in the related document 215. The more important a word is, the more likely it is that a link is attached to the word. As such, the candidate word extraction section 206 can extract important words as the candidate words 216 by considering a word having a link attached thereto to be a candidate word 216. Further, examples of the accompanying information encompass: meta-information such as a file property or an author name; and a hashtag. Note that the technique in which the candidate word extraction section 206 extracts the candidate words 216 is not limited to the above example, and the candidate word extraction section 206 may extract the candidate words 216 from the related document 215 by another technique. Note that the candidate words 216 may include a part or all of extracted words 213.

### Detection of Related Word

The following description will discuss a method of detecting a related word by the related word detection section 208. For example, the related word detection section 208 detects the related word 218 from among the candidate words 216 on the basis of the score 217 indicative of a relevance between the target document 212 and each of the candidate words 216. For example, the score 217 is a real number in a range of 0 to 1, and the closer the score 217 is to 0, the lower relevance is indicated, and the closer the score 217 is to 1, the higher relevance is indicated. However, the score 217 is not limited to such an example. For example, the related word detection section 208 may detect a candidate word 216 and a related word having a calculated score of not less than a threshold.

The score 217 is, for example, a score representing a distance between an embedded vector calculated from each of the candidate words 216 and an embedded vector calculated from the target document 212. Note here that the embedded vector calculated from each of the candidate words 216 may be obtained by directly vectorizing the candidate word 216, or may be a vector obtained by vectorizing a sentence containing the candidate word 216 or vectorizing the sentence and a sentence around the sentence.

Further, an embedded vector calculated from the target document 212 may be a vector obtained by vectorizing the target document 212 as it is, or may be a vector obtained by vectorizing a sentence which contains the extracted word 213 extracted from the target document 212.

Note that the embedded vector is a value calculated by an embedded model which represents given data in a vector space. The embedded model is a model in which data similarity is represented as a spatial distance.

Note that the method for training the embedded model is not limited to a specific one, and a general machine learning technique may be used. For example, the related word detection section 208 may use, as the embedded model, a model trained by a training algorithm using a multilayer neural network.

By using the embedded vector, the related word detection section 208 can calculate the score 217 taking account of a semantic similarity between each of the candidate words 216 and the target document 212.

Further, a method by which the related word detection section 208 calculates the score 217 is not limited to an embedded vector, and can be any method. For example, the related word detection section 208 may use an existing natural language processing technique such as syntactic analysis to vectorize the candidate words 216 and the target document 212 and calculate the score 217.

Further, as another example in which the score calculation section 207 calculates the score 217, for example, the score calculation section 207 may calculate the score 217 with use of a scorer which is used for calculation of a score indicative of a relevance between a search word and a website in a search engine. The scorer, for example, is a learned model generated by performing machine learning of a relevance between a search word and a website.

### Flow of Process

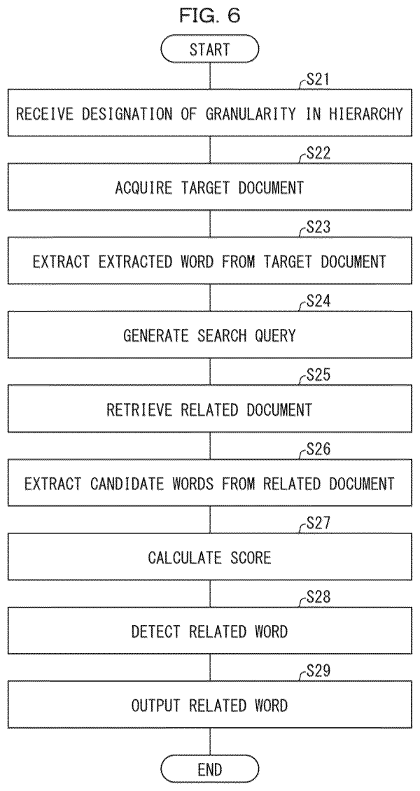

The following will describe, with reference to FIG. 6, a flow of a process (related word detection method) carried out by the information processing apparatus 2. FIG. 6 is a flowchart illustrating a flow of the process carried out by the information processing apparatus 2.

In S21, the reception section 201 receives designation of a granularity in a hierarchy and causes the granularity to be stored in the storage section 21 as the designated granularity 211. In S22, the target document acquisition section 202 acquires a target document and causes the target document to be stored in the storage section 21 as a target document 212. In S23, the extraction section 203 extracts an extracted word from the target document 212 and causes the extracted word to be stored in the storage section 21 as an extracted word 213. In S24, the search query generation section 204 generates a search query with use of the extracted word 213 and causes the search query to be stored in the storage section 21 as a search query 214.

In S25, the related document retrieval section 205 retrieves, with use of the search query 214, a related document from the corpus and causes the related document to be stored in the storage section 21 as a related document 215. In S26, the candidate word extraction section 206 extracts candidate words from the related document 215 and causes the candidate words to be stored in the storage section 21 as candidate words 216.

In S27, the score calculation section 207 calculates a score 217 for each of the candidate words 216. In S28, the related word detection section 208 detects a related word 218 from among the candidate words 216 on the basis of the score 217 calculated by the score calculation section 207.

In S29, the output control section 209 outputs the related word 218 detected by the related word detection section 208. The output control section 209 may output the related word 218 to an output apparatus connected via the output section 23 or the communication section 24. Note that the output of the related word 218 is not essential. For example, the related word detection section 208 may cause the related word 218 to be stored in a storage location designated by the user of the information processing apparatus 2 (the storage location may be in the storage section 21 of the information processing apparatus 2 or may be a storage apparatus outside the information processing apparatus 2), and may end the process illustrated in FIG. 6.

Note that in a case where extracted words 213 are included among related words 218, the output control section 209 may output those of the related words 218 which are other than the extracted words 213, or may output all the related words 218 together including the extracted word 213 included among the related words 218. In the case of outputting both the extracted words 213 and the related words 218, it is preferable that the output control section 209 present the extracted words 213 and the related words 218 (word that are not included among the extracted words 213) in a manner that allows making a distinction between the extracted words 213 and the related words 218, by, for example, displaying the extracted words 213 in a manner different from a manner in which the related words 218 are displayed.

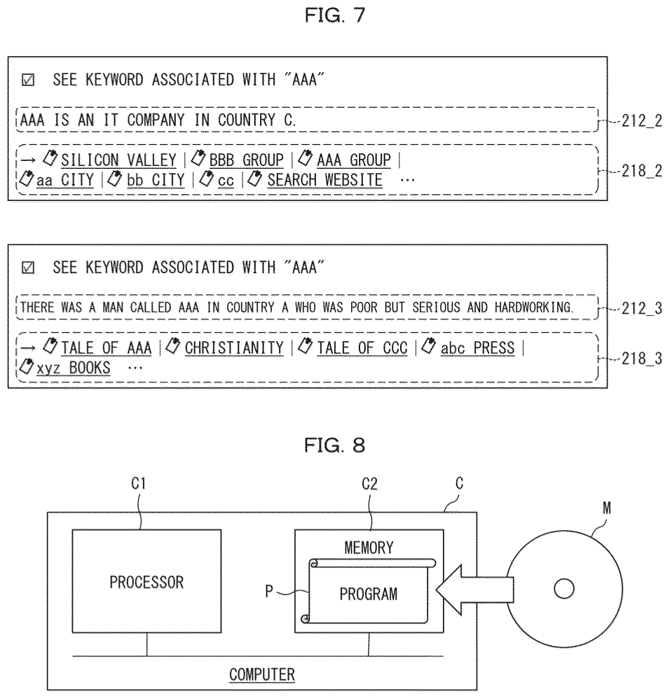

FIG. 7 is a view illustrating an example screen displaying a related word 218, the example screen being outputted by the output control section 209. In FIG. 7, related words 218_2 are each a related word which is detected by the information processing apparatus 2 with respect to an extracted word “AAA” included in the target document. Note that the extracted word is a name of a character in a story, and the name is used also as a company name. 212_2 is a sentence which contains the extracted word in the target document. Related words 218_3 are each a related word which is detected by the information processing apparatus 2 with respect to the extracted word “AAA” included in another target document. 212_3 is a sentence which contains the extracted word in the target document. Note that, in the example screen illustrated in FIG. 7, related words are indicated as “associated keywords”.

As illustrated in FIG. 7, although the extracted word is the same, the related words 218_2 are different from the related words 218_3. Specifically, words corresponding to the fact that the extracted word is used as a company name are presented as the related words 218_2, whereas words corresponding to the fact that the extracted word is used as a character name of a story are presented as the related words 218_3. Thus, the information processing apparatus 2 makes it possible to extract, for the respective target documents 212_2 and 212_3, related words 218_2 and 218_3 which well capture the contexts of the target documents, including words that are not included in the target documents.

### Advantageous Effect of Information Processing Apparatus

As described above, according to the present example embodiment, a related document 215 related to an extracted word 213 extracted from a target document 212 is retrieved, and a related word 218 is detected from the retrieved related document 215. This makes it possible to detect a related word 218 that is not included in the target document 212. Further, according to the present example embodiment, it is possible to handle new domains, new words, and new concepts by simply replacing (or adding) a corpus. That is, according to the present example embodiment, a detection process that can handle new topics can be carried out by merely replacing or adding a corpus, without having to re-train the model.

Further, the information processing apparatus 2 in accordance with the present example embodiment employs a configuration which: words constituting the target document 212 are classified in a hierarchical structure; and the information processing apparatus 2 includes (i) the reception section 201 that receives designation of a granularity in a hierarchy and (ii) the extraction section 203 that extracts, on the basis of the granularity designated, the extracted word 213 from among the words constituting the target document 212. The configuration provides, in addition to the effect of the information processing apparatus 1 in accordance with the first example embodiment, an advantageous effect that the related word 218 can be detected in accordance with the extracted word 213 extracted with a granularity desired by a user.

Further, the information processing apparatus 2 in accordance with the present example embodiment employs a configuration in which: the information processing apparatus 2 includes the search query generation section 204 that generates a search query 214 including (i) the extracted word 213 extracted from the target document 212 and (ii) a sentence included in the target document 212 and containing the extracted word 213; and the related document retrieval section 205 retrieves the related document 215 with use of the search query 214. The configuration makes it possible to carry out retrieval in consideration of a context of the sentence containing an extracted word 213, and thus makes it possible to detect a related document 215 that is high in validity.

Further, the information processing apparatus 2 in accordance with the present example embodiment employs a configuration in which: the related document retrieval section 205 retrieves the related document 215 from a corpus including a plurality of documents; and the corpus includes a reconstructed document generated by reconstruction of a document with use of an important word which is relatively high in importance among words included in the document.

In a reconstructed document reconstructed with use of an important word extracted from the document, key points are compactly presented in comparison with the original document. As such, a relevance between an extracted word 213 extracted from the target document 212 and the reconstructed document can be determined relatively accurately. As such, the above configuration makes it possible to detect a related document 215 that is high in validity.

Further, the information processing apparatus 2 in accordance with the present example embodiment employs a configuration in which the information processing apparatus 2 includes the candidate word extraction section 206 that extracts, as the candidate words 216, important words which are relatively high in importance and are identified on the basis of at least one selected from the group consisting of: structure information indicative of a structure of the related document 215; and accompanying information which accompanies the related document 215. According to this configuration, it is possible to extract, as the candidate words 216, important words which are considered to be highly important.

Further, the information processing apparatus 2 in accordance with the present example embodiment employs a configuration in which: the information processing apparatus 2 includes the score calculation section 207 that calculates, with use of a scorer, a score 217 indicative of a relevance between the target document 212 and each of the candidate words 216, the scorer being used for calculation of a score indicative of a relevance between a search word and a website in a search engine; and the related word detection section 208 detects the related word 218 from among the candidate words 216 on the basis of the score 217.

The search engine calculates a score indicative of a relevance between a search word inputted by a user and each website to be searched, and presents websites to the user in descending order of scores. As a scorer for calculating the above score, a scorer capable of accurately calculating a score indicative of a relevance between the search word and the website has been applied, and continuous improvement is being made to further enhance the calculation accuracy of the score.

According to The above configuration, with use of such a scorer used for calculation of the score, a score 217 indicative of a relevance between the target document 212 and each of the candidate words 216 is calculated, and a related word 218 is detected on the basis of the score 217. As such, a reasonable related word 218 can be detected on the basis of the score 217 that accurately represents the relevance between the target document 212 and each of the candidate words 216.

### Variation

The processes described in the example embodiments above may be carried out by any entity, not confined to the above-described examples. That is, a related word detection system having functions similar to those of the information processing apparatus 2 can be constructed by a plurality of apparatuses capable of communicating with each other. For example, a related word detection system having functions similar to those of the information processing apparatus 2 can be constructed by dispersedly providing, in a plurality of apparatuses, blocks illustrated in FIG. 4. For example, the retrieval of the related document 215 and the detection of the related word 218 may be carried out by respective different apparatuses. Further, the processes included in the flow in FIG. 6 may be carried out by a plurality of apparatuses (processors).

### Software Implementation Example

Some or all of the functions of each of the information processing apparatuses 1 and 2 may be implemented by hardware such as an integrated circuit (IC chip), or may be alternatively implemented by software.

In the latter case, the information processing apparatus 1 or 2 is realized by, for example, a computer that executes instructions of a program that is software realizing the foregoing functions. FIG. 8 illustrates an example of the computer (hereinafter referred to as “computer C”). The computer C includes at least one processor C1 and at least one memory C2. The at least one memory C2 stores a program P (related word detection program) for causing the computer C to operate as each of the information processing apparatuses 1 and 2. In the computer C, the foregoing functions of the information processing apparatus 1 or 2 can be realized by the processor C1 reading and executing the program P stored in the memory C2.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded at the time of execution and in which various data are temporarily stored. The computer C may further include a communication interface for carrying out transmission and reception of data to and from another apparatus. The computer C may further include an input-output interface via which input-output equipment such as a keyboard, a mouse, a display or a printer is connected.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via the recording medium M. The program P can be transmitted via a transmission medium. Examples of such a transmission medium can include a communication network and a broadcast wave. The computer C can acquire the program P also via the transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to the following supplementary notes.

### Supplementary Note 1

An information processing apparatus, including: a related document retrieval means that retrieves, with use of an extracted word extracted from a target document, a related document related to the extracted word; and a related word detection means that detects, from among candidate words extracted from the related document detected by the related document retrieval means, a related word related to the target document.

### Supplementary Note 2

The information processing apparatus described in supplementary note 1, wherein words constituting the target document are classified in a hierarchical structure, the information processing apparatus further including: a reception means that receives designation of a granularity in a hierarchy; and an extraction means that extracts, on the basis of the granularity designated, the extracted word from among the words constituting the target document.

### Supplementary Note 3

The information processing apparatus described in supplementary note 1 or 2, further including a search query generation means that generates a search query including: the extracted word extracted from the target document; and a sentence included in the target document and containing the extracted word, the related document retrieval means retrieving the related document with use of the search query.

### Supplementary Note 4

The information processing apparatus described in any one of supplementary notes 1 to 3, wherein: the related document retrieval means retrieves the related document from a corpus including a plurality of documents; and the corpus includes a reconstructed document generated by reconstruction of a document with use of an important word which is relatively high in importance among words included in the document.

### Supplementary Note 5

The information processing apparatus described in any one of supplementary notes 1 to 4, further including a candidate word extraction means that extracts, as the candidate words, important words which are relatively high in importance and are identified on the basis of at least one selected from the group consisting of: structure information indicative of a structure of the related document; and accompanying information which accompanies the related document.

### Supplementary Note 6

The information processing apparatus described in any one of supplementary notes 1 to 5, further including a score calculation means that calculates, with use of a scorer, a score indicative of a relevance between the target document and each of the candidate words, the scorer being used for calculation of a score indicative of a relevance between a search word and a website in a search engine, the related word detection means detecting the related word from among the candidate words on the basis of the score.

### Supplementary Note 7

A related word detection method, including: retrieving, by at least one processor and with use of an extracted word extracted from a target document, a related document related to the extracted word; and detecting, by the at least one processor and from among candidate words extracted from the related document, a related word related to the target document.

### Supplementary Note 8

A related word detection program for causing a computer to function as: a related document retrieval means that retrieves, with use of an extracted word extracted from a target document, a related document related to the extracted word; and a related word detection means that detects, from among candidate words extracted from the related document detected by the related document retrieval means, a related word related to the target document.

### Additional Remark 3

The whole or part of the example embodiments disclosed above can also be expressed as follows.

An information processing apparatus, including at least one processor, the at least one processor carrying out: a related document retrieval process of retrieving, with use of an extracted word extracted from a target document, a related document related to the extracted word; and a related word detection process of detecting, from among candidate words extracted from the related document detected in the related document retrieval process, a related word related to the target document.

Note that the information processing apparatus may further include a memory, which may store therein a program for causing the at least one processor to carry out the related document retrieval process and the related word detection process. In addition, this program may be recorded on a computer-readable, non-transitory, and tangible recording medium.

### REFERENCE SIGNS LIST

1, 2: Information processing apparatus
11, 205: Related document retrieval section
12, 208: Related word detection section
203: Extraction section
204: Search query generation section
206: Candidate word extraction section
207: Score calculation section

What is claimed is:

1. An information processing apparatus, comprising at least one processor, the at least one processor carrying out:
a related document retrieval process of retrieving, with use of an extracted word extracted from a target document, a related document related to the extracted word; and
a related word detection process of detecting, from among candidate words extracted from the related document detected in the related document retrieval process, a related word related to the target document.

2. The information processing apparatus according to claim 1, wherein words constituting the target document are classified in a hierarchical structure,
the at least one processor further carrying out:
a reception process of receiving designation of a granularity in a hierarchy; and
an extraction process of extracting, on the basis of the granularity designated, the extracted word from among the words constituting the target document.

3. The information processing apparatus according to claim 1, wherein
the at least one processor further carries out a search query generation process of generating a search query including: the extracted word extracted from the target document; and a sentence included in the target document and containing the extracted word, and
in the related document retrieval process, the at least one processor retrieves the related document with use of the search query.

4. The information processing apparatus according to claim 1, wherein:
in the related document retrieval process, the at least one processor retrieves the related document from a corpus including a plurality of documents; and
the corpus includes a reconstructed document generated by reconstruction of a document with use of an important word which is relatively high in importance among words included in the document.

5. The information processing apparatus according to claim 1, wherein the at least one processor further carries out a candidate word extraction process of extracting, as the candidate words, important words which are relatively high in importance and are identified on the basis of at least one selected from the group consisting of: structure information indicative of a structure of the related document; and accompanying information which accompanies the related document.

6. The information processing apparatus according to claim 1, wherein the at least one processor further carries out a score calculation process of calculating, with use of a scorer, a score indicative of a relevance between the target document and each of the candidate words, the scorer being used for calculation of a score indicative of a relevance between a search word and a website in a search engine, and
in the related word detection process, the at least one processor detects the related word from among the candidate words on the basis of the score.

7. A related word detection method, comprising:
retrieving, by at least one processor and with use of an extracted word extracted from a target document, a related document related to the extracted word; and
detecting, by the at least one processor and from among candidate words extracted from the related document, a related word related to the target document.

8. A computer-readable, non-transitory storage medium storing a related word detection program for causing a computer to function as:
a related document retrieval means that retrieves, with use of an extracted word extracted from a target document, a related document related to the extracted word; and
a related word detection means that detects, from among candidate words extracted from the related document detected by the related document retrieval means, a related word related to the target document.
